(19) United States
(12) Patent Application Publication
(10) Pub. No.: US 2016/0135047 A1
(43) Pub. Date: May 12, 2016

(54) USER TERMINAL AND METHOD FOR UNLOCKING SAME

(71) Applicant: SAMSUNG ELECTRONICS CO., LTD., Suwon-si (KR)

(72) Inventors: Keun Joo PARK, Seoul (KR); Youngwan SEO, Seoul (KR); Changwoo SHIN, Hwaseong-si (KR); Jooyeon WOO, Hwaseong-si (KR)

(73) Assignee: SAMSUNG ELECTRONICS CO., LTD., Suwon-si (KR)

(21) Appl. No.: 14/716,461

(22) Filed: May 19, 2015

(30) Foreign Application Priority Data
Nov. 12, 2014 (KR) 10-2014-0156909

(51) Int. Cl. H04W 12/06; G10L 15/14; G10L 15/26; G10L 25/30; H04W 12/08; G10L 15/22

(52) U.S. Cl. CPC H04W 12/06; H04W 12/08; G10L 15/22; G10L 15/26; G10L 25/30; G10L 15/142; G10L 2015/223

(57) ABSTRACT

A user terminal and a method for unlocking the user terminal are provided. The method includes determining whether to generate a wakeup signal that wakes up a processor, based on a tone comprised in a voice signal; and determining, by the processor, whether to unlock the user terminal based on a text extracted from the voice signal, in response to the wakeup signal being generated.

### CROSS-REFERENCE TO RELATED APPLICATION

This application claims priority from Korean Patent Application No. 10-2014-0156909, filed on Nov. 12, 2014 in the Korean Intellectual Property Office, the disclosure of which is incorporated herein by reference in its entirety.

### BACKGROUND

1. Field

Apparatuses and methods consistent with exemplary embodiments relate to a user terminal and a method for unlocking the user terminal.

2. Description of the Related Art

Use of voice recognition technology has been gradually increasing due to generalization of high-specification devices such as smartphones and tablet computers. The voice recognition technology may recognize a voice signal input from a user as a signal corresponding to a language. Using such a voice recognition technology may allow a user to conveniently operate a user terminal through a voice command.

To use such a user terminal conveniently, unlocking the user terminal is a prerequisite. The unlocking of the user terminal, in most instances, may be performed through a touch or a gesture performed by the user in lieu of a voice command. The unlocking of the user terminal through the touch or the gesture may be inconvenient due to the user having to move a hand and the like, although the unlocking through the touch or the gesture may accurately convey an intention of the user. Whereas, the unlocking of the user terminal through the voice command may require a sensor and a processor of the user terminal to consume a considerable amount of power in order to continuously monitor a voice expressed by the user.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a method of unlocking a user terminal, the method including determining whether to generate a wakeup signal that wakes up a processor, based on a tone comprised in a voice signal; and determining, by the processor, whether to unlock the user terminal based on a text extracted from the voice signal, in response to the wakeup signal being generated.

The method may further include changing, by the processor, from a sleep mode to a wakeup mode in response to the wakeup signal being generated.

The determining whether to generate the wakeup signal may include determining whether to generate the wakeup signal based on whether the tone comprised in the voice signal corresponds to a tone comprised in a preregistered voice signal.

The determining whether to generate the wakeup signal may include detecting the tone comprised in the voice signal based on a portion of the voice signal to be used by the processor.

The determining whether to generate the wakeup signal may include dividing the voice signal into frequency bands based on a first frequency bandwidth that is broader than a second frequency bandwidth to be used by the processor; and detecting the tone comprised in the voice signal based on the frequency bands.

The determining whether to generate the wakeup signal may include detecting the tone comprised in the voice signal based on one of a ratio of magnitudes of frequency bands comprised in the voice signal, an application of a support vector machine to the frequency bands, and an application of a neural network to the frequency bands.

The determining whether to unlock the user terminal may include determining whether to unlock the user terminal based on whether the text extracted from the voice signal corresponds to a text extracted from a preregistered voice signal.

The determining whether to unlock the user terminal may include extracting the text from the voice signal based on one of a ratio of magnitudes of frequency bands comprised in the voice signal, an application of a recurrent neural network to the frequency bands, and an application of a hidden Markov model to the frequency bands.

The method may further include changing, by the processor, from a wakeup mode to a sleep mode in response to the user terminal being not unlocked within a predetermined period of time from a point in time at which the processor receives the wakeup signal.

The determining whether to generate the wakeup signal may include transmitting the voice signal stored in a memory to the processor in response to the wakeup signal being generated.

According to an aspect of another exemplary embodiment, there is provided a user terminal including: a wakeup determiner configured to determine whether to generate a wakeup signal that wakes up an unlocking determiner, based on a tone comprised in a voice signal; and the unlocking determiner configured to determine whether to unlock the user terminal based on a text extracted from the voice signal, in response to the wakeup signal being generated.

The unlocking determiner may be configured to change from a sleep mode to a wakeup mode in response to the wakeup signal being generated.

The wakeup determiner may be configured to determine whether to generate the wakeup signal based on whether the tone comprised in the voice signal corresponds to a tone comprised in a preregistered voice signal.

The wakeup determiner may be configured to detect the tone comprised in the voice signal based on a portion of the voice signal to be used by the unlocking determiner.

The wakeup determiner may be configured to divide the voice signal into frequency bands based on a first frequency bandwidth that is broader than a second frequency bandwidth to be used by the unlocking determiner; and detect the tone comprised in the voice signal based on the frequency bands.

The wakeup determiner may be configured to detect the tone comprised in the voice signal based on one of a ratio of magnitudes of frequency bands comprised in the voice signal, an application of a support vector machine to the frequency bands, and an application of a neural network to the frequency bands.

The unlocking determiner may be configured to determine whether to unlock the user terminal based on whether the text extracted from the voice signal corresponds to a text extracted from a preregistered voice signal.

The unlocking determiner may be configured to extract the text from the voice signal based on one of a ratio of magnitudes of frequency bands comprised in the voice signal, an application of a recurrent neural network to the frequency bands, and an application of a hidden Markov model to the frequency bands.

In response to the user terminal being not unlocked within a predetermined period of time from a point in time at which the unlocking determiner receives the wakeup signal is received from the wakeup determiner, the unlocking determiner may be configured to change the mode from the a wakeup mode to the a sleep mode.

### BRIEF DESCRIPTION OF THE DRAWINGS

The above and other aspects of exemplary embodiments will become apparent and more readily appreciated from the following detailed description of certain exemplary embodiments, taken in conjunction with the accompanying drawings of which:

FIG. 1 is a block diagram illustrating a user terminal in which a method of unlocking the user terminal is performed according to an exemplary embodiment;

FIG. 2 is a diagram illustrating a digital type user terminal according to an exemplary embodiment;

FIG. 3 is a diagram illustrating an operation of detecting a tone included in a voice signal of a user in a digital method according to an exemplary embodiment;

FIG. 4 is a diagram illustrating an operation of extracting a text from a voice signal of a user in a digital method according to an exemplary embodiment;

FIG. 5 is a diagram illustrating an analog type user terminal according to an exemplary embodiment;

FIG. 6 is a diagram illustrating an operation of detecting a tone included in a voice signal of a user in an analog method according to an exemplary embodiment;

FIG. 7 is a diagram illustrating an operation of extracting a text from a voice signal of a user in an analog method according to an exemplary embodiment;

FIGS. 8A and 8B are diagrams illustrating operations of using a neural network and a recurrent neural network (RNN), respectively, according to exemplary embodiments;

FIGS. 9A through 9C are diagrams illustrating an operation of sampling a voice signal of a user according to an exemplary embodiment; and

FIG. 10 is a flowchart illustrating a method of unlocking a user terminal to be performed by the user terminal according to an exemplary embodiment.

### DETAILED DESCRIPTION

Reference will now be made in detail to exemplary embodiments, examples of which are illustrated in the accompanying drawings, wherein like reference numerals refer to the like elements throughout. Exemplary embodiments are described below in order to explain the present disclosure by referring to the figures.

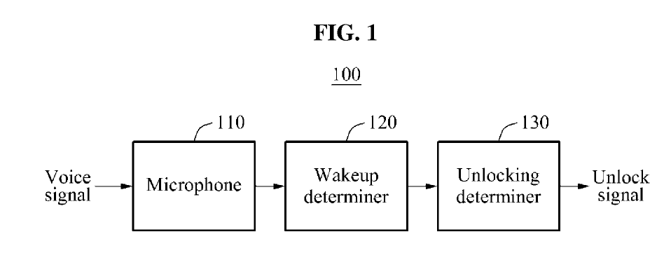

FIG. 1 is a block diagram illustrating a user terminal 100 in which a method of unlocking the user terminal 100 is performed according to an exemplary embodiment.

Referring to FIG. 1, the user terminal 100 includes a microphone 110, a wakeup determiner 120, and an unlocking determiner 130. The user terminal 100 may refer to a device processing a voice signal input from a user, and include, for example, a mobile device such as a mobile phone, a smartphone, a personal digital assistant (PDA), and a tablet computer, a wearable device such as a smart watch and smart glasses, an electrical smart appliance such as a smart television (TV), a smart refrigerator, and a smart door lock, a general computing device such as a laptop computer and a personal computer, and a special computing device such as a vehicle navigation device, an automated teller machine (ATM), and an automatic ticket vending machine. The user terminal 100 may include various modules processing a voice signal of a user. The modules may include a hardware module (such as a processor, integrated circuit, etc.), a software module, or a combination thereof. The user terminal 100 may also refer to a device authenticating a user based on a voice signal of the user, and a preregistered voice signal. The preregistered voice signal may refer to a voice signal input in advance from the user, and be stored in an internal or external memory of the user terminal 100.

The microphone 110 refers to a device receiving a voice signal input from a user. The microphone 110 transmits the voice signal of the user to the wakeup determiner 120.

The wakeup determiner 120 determines whether to generate a wakeup signal based on the voice signal of the user. The wakeup signal may indicate a signal that wakes up the unlocking determiner 130 that performs voice recognition. The wakeup determiner 120 may include an always-ON sensor. Thus, the wakeup determiner 120 may operate in a permanent ON state irrespective of whether the voice signal is input from the user.

The wakeup determiner 120 may determine whether to generate the wakeup signal based on whether a tone included in the voice signal corresponds to a tone included in a preregistered voice signal. For example, when the tone included in the voice signal of the user corresponds to the tone included in the preregistered voice signal, the wakeup determiner 120 may generate the wakeup signal, which indicates an ON signal. Conversely, when the tone included in the voice signal of the user does not correspond to the tone included in the preregistered voice signal, the wakeup determiner 120 may not generate the voice signal, which indicates an OFF signal.

The wakeup determiner 120 may detect the tone included in the voice signal of the user, using a portion of the voice signal of the user to be used in the unlocking determiner 130. The wakeup determiner 120 may detect the tone included in the voice signal of the user based on a plurality of first frequency bands generated by sub-sampling the voice signal of the user. The first frequency bands may be generated by dividing the voice signal of the user based on a first frequency bandwidth. The first frequency bandwidth may be broader than a second frequency bandwidth to be used in the unlocking determiner 130.

For example, the wakeup determiner 120 may detect the tone included in the voice signal of the user by using a ratio of magnitudes of the first frequency bands or applying any one of a support vector machine (SVM) and a neural network to the first frequency bands.

The wakeup determiner 120 may detect the tone included in the preregistered voice signal by applying a method described in the foregoing to the tone included in the preregistered voice signal in addition to the received voice signal of the user. The wakeup determiner 120 may determine whether the tone included in the voice signal of the user corresponds to the tone included in the preregistered voice signal.

For example, when the tone included in the input voice signal of the user differs from a tone of a preregistered user, or when the input voice signal is noise and not a human voice signal, the wakeup determiner 120 may determine that the tone included in the voice signal of the user and the tone included in the preregistered voice signal do not correspond and thus, may not generate the wakeup signal.

The unlocking determiner 130 determines whether to unlock the user terminal 100 based on a text extracted from the voice signal of the user through voice recognition. The unlocking determiner 130 is on standby in a sleep mode until the wakeup signal is received from the wakeup determiner 120. When the wakeup signal generated by the wakeup determiner 120 is received, the unlocking determiner 130 changes a mode from the sleep mode to a wakeup mode. The sleep mode may refer to a mode to minimize an amount of power consumption, and the unlocking determiner 130 determines whether the wakeup signal is input in the sleep mode. The wakeup mode may refer to a mode to process an input signal. Thus, when the wakeup signal is input, the unlocking determiner 130 changes the mode to the wakeup mode, and performs signal processing.

The unlocking determiner 130 may determine whether to unlock the user terminal 100 based on whether the text extracted from the voice signal through the voice recognition corresponds to a text extracted from a preregistered voice signal. For example, when the text extracted from the voice signal of the user through the voice recognition corresponds to the text extracted from the preregistered voice signal, the unlocking determiner 130 may generate an unlock signal to unlock the user terminal 100. Conversely, when the text extracted from the voice signal of the user through the voice recognition does not correspond to the text extracted from the preregistered voice signal, the unlocking determiner 130 may not generate the unlock signal to unlock the user terminal 100. Hereinafter, for ease of description, it is assumed that the unlocking determiner 130 generates the unlock signal when the user terminal 100 is determined to be unlocked.

The unlocking determiner 130 may extract the text included in the voice signal of the user based on a plurality of second frequency bands generated by full-sampling the voice signal of the user. The second frequency bands may be generated by dividing the voice signal of the user based on the second frequency bandwidth. The second frequency bandwidth may be narrower than the first frequency bandwidth to be used in the wakeup determiner 120.

For example, the unlocking determiner 130 may extract the text from the voice signal of the user by using a ratio of magnitudes of the second frequency bands included in the voice signal of the user or applying any one of a recurrent neural network (RNN) and a hidden Markov model (HMM) to the second frequency bands.

The unlocking determiner 130 may extract the text from the preregistered voice signal by applying a method described in the foregoing to the preregistered voice signal in addition to the voice signal of the user. Thus, the unlocking determiner 130 may determine whether the text extracted from the voice signal of the user corresponds to the text extracted from the preregistered voice signal.

When the user terminal 100 is not unlocked within a predetermined period of time from a point in time at which the wakeup signal is received from the wakeup determiner 120, the unlocking determiner 130 changes the mode from the wakeup mode to the sleep mode. For example, when the text extracted from the voice signal of the user is not determined to correspond to the text extracted from the preregistered voice signal within the predetermined period of time after the mode is changed to the wakeup mode, the unlocking determiner 130 may return to the sleep mode.

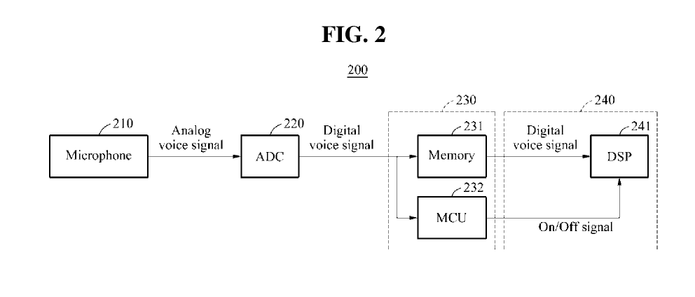

FIG. 2 is a diagram illustrating a digital type user terminal 200 according to an exemplary embodiment.

Referring to FIG. 2, the user terminal 200 digitally operates, and includes a microphone 210, an analog-to-digital converter (ADC) 220, a wakeup determiner 230, and an unlocking determiner 240.

The ADC 220 refers to a device converting an analog signal to a digital signal, and receives an analog voice signal of a user from the microphone 210. The ADC 220 converts the analog voice signal to a digital voice signal, and transmits the digital voice signal to the wakeup determiner 230. For example, the ADC 220 may operate in a frequency band greater than or equal to 40 kilohertz (kHz) based on a Nyquist theorem because an audible frequency band of a human being is generally in a range between 20 hertz (Hz) and 20,000 Hz.

The wakeup determiner 230 determines whether to generate a wakeup signal based on the digital voice signal of the user. The digital type wakeup determiner 230 includes a memory 231 and a microcontroller unit (MCU) 232.

The memory 231 stores the digital voice signal of the user that is received from the ADC 220. When the wakeup signal is generated by the MCU 232, the memory 231 transmits the stored digital voice signal to the unlocking determiner 240. Here, an amount of time may be consumed for the unlocking determiner 240 receiving the wakeup signal to change a mode from a sleep mode to a wakeup mode. The memory 231 may operate as a buffer to transmit the stored digital voice signal of the user to the unlocking determiner 240 after the unlocking determiner 240 changes the mode to the wakeup mode. For example, the memory 231 may include a random access memory (RAM).

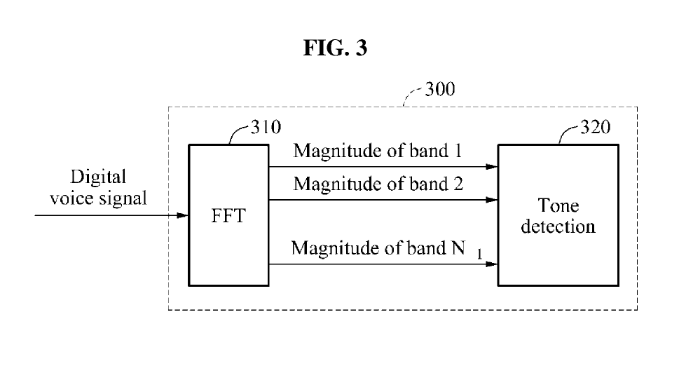

The MCU 232 may refer to a processor capable of performing a simple computation. The MCU 232 may also be a processor with a lower amount of computation and power consumption than a digital signal processor (DSP) 241 included in the unlocking determiner 240. The MCU 232 determines whether to generate the wakeup signal based on a tone included in the digital voice signal of the user that is received from the ADC 220. For example, when the tone included in the digital voice signal of the user corresponds to a tone included in a preregistered voice signal, the MCU 232 may generate the wakeup signal, which indicates an ON signal, and transmit the wakeup signal to the DSP 241 of the unlocking determiner 240. Conversely, when the tone included in the digital voice signal of the user does not correspond to the tone included in the preregistered voice signal, the MCU 232 may not generate the wakeup signal, which indicates an OFF signal. A detailed operation of the MCU 232 will be described with reference to FIG. 3.

The unlocking determiner 240 determines whether to unlock the user terminal 200 based on a text extracted from the digital voice signal of the user through voice recognition. The digital type unlocking determiner 240 includes the DSP 241.

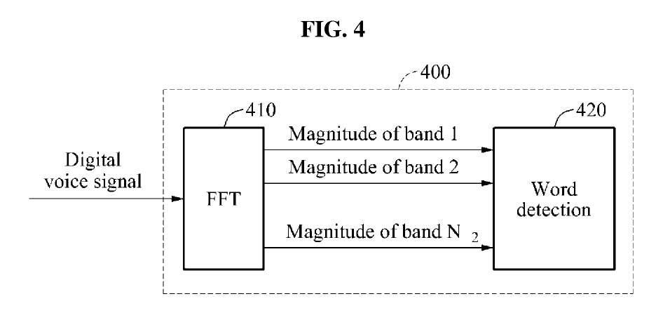

The DSP 241 refers to a processor capable of processing an input digital signal. The DSP 241 may also be a processor with a greater amount of computation and power consumption than the MCU 232 included in the wakeup determiner 230. When the wakeup signal generated in the MCU 232 is received, the DSP 241 changes the mode from the sleep mode to the wakeup mode. The DSP 241 in the wakeup mode receives the digital voice signal of the user from the memory 231. The DSP 241 determines whether to unlock the user terminal 200 based on the text extracted from the digital voice signal of the user through the voice recognition. A detailed operation of the DSP 241 will be described with reference to FIG. 4.

FIG. 3 is a diagram illustrating an operation of detecting a tone included in a voice signal of a user in a digital method according to an exemplary embodiment.

Referring to FIG. 3, an MCU 300 performs a fast Fourier transform (FFT) 310 on a digital voice signal input from a user. The MCU 300 converts the digital voice signal of the user in a time domain to a plurality of first frequency bands in a frequency domain through the FFT 310. A number of the first frequency bands is N₁. For example, when a human voice signal is present in a range between 50 Hz and 5,000 Hz and the number N₁ of the first frequency bands is 10, a frequency bandwidth may be set to be approximately 500 Hz subsequent to the FFT 310. Thus, the MCU 300 may perform the FFT 310 by setting an FFT time window to be 2 milliseconds (ms). In another example, when a human voice signal is present between 500 Hz and 2,000 Hz in the range between 50 Hz and 5,000 Hz and the number N₁ of the first frequency bands is 10, a frequency bandwidth may be set to be approximately 200 Hz subsequent to the FFT 310. Thus, the MCU 300 may perform the FFT 310 by setting the FFT time window to be 5 ms. However, a frequency band of the digital voice signal and the number N₁ of the first frequency bands may not be limited to the examples described in the foregoing.

The MCU 300 detects magnitudes of the first frequency bands generated by performing the FFT 310 on the digital voice signal of the user. In a tone detection 320, the MCU 300 determines whether a tone included in the digital voice signal of the user corresponds to a tone included in a preregistered voice signal based on the magnitudes of the first frequency bands.

In an example, the MCU 300 may calculate a similarity between a ratio of the magnitudes of the first frequency bands transformed from the digital voice signal of the user and a ratio of magnitudes of third frequency bands of the preregistered voice signal. When the calculated similarity is greater than a predetermined threshold value, the MCU 300 may determine that the tone included in the digital voice signal of the user corresponds to the tone included in the preregistered voice signal. Conversely, when the calculated similarity is less than the predetermined threshold value, the MCU 300 may determine that the tone included in the digital voice signal of the user does not correspond to the tone included in the preregistered voice signal. When the calculated similarity is equal to the predetermined threshold value, the MCU 300 may determine that the tone included in the digital voice signal of the user corresponds to or does not correspond to the tone included in the preregistered voice signal based on predetermined settings.

In another example, the MCU 300 may determine whether the tone included in the digital voice signal of the user corresponds to the tone included in the preregistered voice signal by applying any one of an SVM and a neural network to the magnitudes of the first frequency bands of the digital voice signal of the user. The SVM may be used for a classification and a recurrence algorithm, and indicate a supervised learning model or an algorithm that analyzes data and recognizes a pattern. As indicated in a neuron, which is a basic structural organization of a human brain and connected to other neurons to process data, the neural network may indicate an algorithm that processes data through a network formed with interconnected neurons as a mathematical model.

FIG. 4 is a diagram illustrating an operation of extracting a text from a voice signal of a user in a digital method according to an exemplary embodiment.

Referring to FIG. 4, when a wakeup signal is received from an MCU of a wakeup determiner, a DSP 400 changes a mode from a sleep mode to a wakeup mode, and receives a digital voice signal of a user from a memory of the wakeup determiner. The DSP 400 performs FFT 400 on the received digital voice signal of the user. The DSP 400 converts the digital voice signal of the user in a time domain to a plurality of second frequency bands in a frequency domain through the FFT 410. A number of the second frequency bands is N₂. For example, when a human voice signal is present in a range between 50 Hz and 5,000 Hz and the number N₂ of the second frequency bands is 100, a frequency bandwidth may be set to be approximately 50 Hz subsequent to the FFT 410. Thus, the DSP 400 may perform the FFT 410 by setting an FFT time window to be 20 ms. In another example, when a human voice signal is present between 500 Hz and 2,000 Hz and the number N₂ of the second frequency bands is 100, the frequency bandwidth may be set to be approximately 20 Hz subsequent to the FFT 410. Thus, the DSP 400 may perform the FFT 410 by setting the FFT time window to be 50 ms. However, a frequency band of the digital voice signal to be input and the number N₂ of the second frequency bands may not be limited to the examples described in the foregoing.

The DSP 400 detects magnitudes of the second frequency bands generated by performing the FFT 410 on the digital voice signal of the user. In a word detection 420, the DSP 400 determines whether a text extracted from the digital voice signal of the user corresponds to a text extracted from a preregistered voice signal based on the magnitudes of the second frequency bands.

In an example, the DSP 400 may calculate a similarity between a ratio of the magnitudes of the second frequency bands transformed from the digital voice signal of the user and a ratio of magnitudes of fourth frequency bands of the preregistered voice signal. When the calculated similarity is greater than a predetermined threshold value, the DSP 400 may determine that the text extracted from the digital voice signal of the user corresponds to the text extracted from the preregistered voice signal. Conversely, when the calculated similarity is less than the predetermined threshold value, the DSP 400 may determine that the text extracted from the digital voice signal of the user does not correspond to the text extracted from the preregistered voice signal. When the calculated similarity is equal to the predetermined threshold value, the DSP 400 may determine whether the text extracted from the digital voice signal of the user corresponds to the text extracted the preregistered voice signal based on predetermined settings.

In another example, the DSP 400 may determine whether the text extracted from the digital voice signal of the user corresponds to the text extracted from the preregistered voice signal by applying any one of an RNN and an HMM to the magnitudes of the second frequency bands transformed from the digital voice signal of the user. For example, the DSP 400 may sequentially recognize a text with time by inputting, to the HMM, outputs of frequency bands.

The RNN may indicate a type of artificial neural network that connects units forming a directed cycle. The HMM may indicate an algorithm of voice recognition technology that may be obtained by statistically modeling a voice unit, for example, a phoneme or a word. Both the RNN and the HMM may be algorithms used to recognize a word.

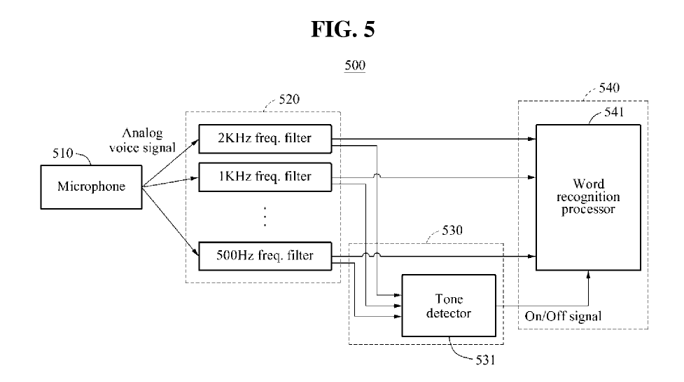

FIG. 5 is a diagram illustrating an analog type user terminal 500 according to an exemplary embodiment.

Referring to FIG. 5, the user terminal 500 operates in an analog method, and includes a microphone 510, a filter array 520, a wakeup determiner 530, and an unlocking determiner 540.

The filter array 520 includes a plurality of analog frequency filters. The filter array 520 filters an analog voice signal of a user that is received from the microphone 510 to a plurality of first frequency bands and to a plurality of second frequency bands. The filter array 520 outputs the first frequency bands to the wakeup determiner 530 and the second frequency bands to the unlocking determiner 540. Although the filter array 520 is illustrated to include 500 Hz to 2,000 Hz band pass filters in FIG. 5, the filter array 520 may not be limited thereto.

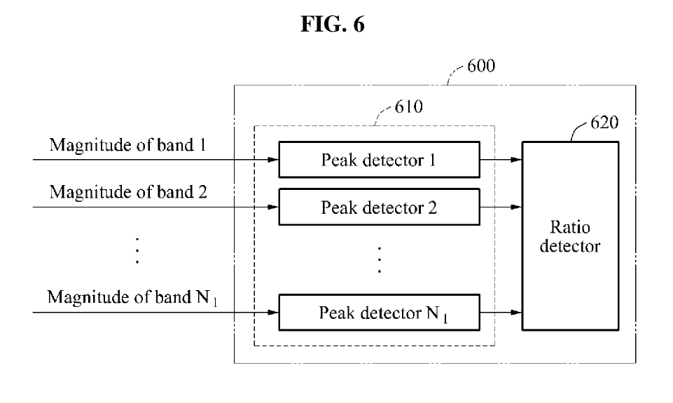

The wakeup determiner 530 determines whether to generate a wakeup signal based on the analog voice signal of the user. The wakeup determiner 530 of an analog type includes a tone detector 531. The tone detector 531 may be a processor with a lower amount of computation and power consumption than a word recognition processor 541 of the unlocking determiner 540. For example, when a tone included in the analog voice signal of the user corresponds to a tone included in a preregistered voice signal, the tone detector 531 may generate the wakeup signal, which indicates an ON signal, and transmit the generated wakeup signal to the word recognition processor 541 of the unlocking determiner 540. However, when the tone included in the analog voice signal of the user does not correspond to the tone included in the preregistered voice signal, the tone detector 531 may not generate the wakeup signal, which indicates an OFF signal. A detailed operation of the tone detector 531 will be described with reference to FIG. 6.

The unlocking determiner 540 determines whether to unlock the user terminal 500 based on a text extracted from the analog voice signal of the user through voice recognition. The unlocking determiner 540 of an analog type includes the work recognition processor 541. The word recognition processor 541 may be a processor with a greater amount of computation and power consumption than the tone detector 531 of the wakeup determiner 530. The word recognition processor 541 may operate in an event method, and operate immediately after receiving the wakeup signal from the tone detector 531 and thus, may not require an additional memory.

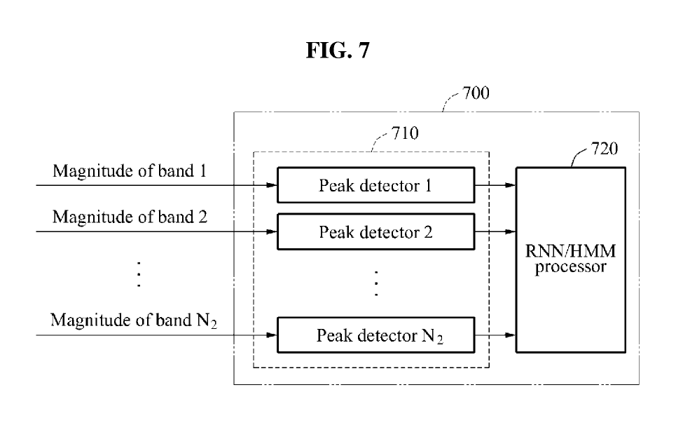

When the wakeup signal generated by the tone detector 531 is received, the word recognition processor 541 changes a mode from a sleep mode to a wakeup mode. The word recognition processor 541 for which the mode is changed to the wakeup mode determines whether to unlock the user terminal 500 based on the text extracted from the analog voice signal of the user through the voice recognition. A detailed operation of the word recognition processor 541 will be described with reference to FIG. 7.

FIG. 6 is a diagram illustrating an operation of detecting a tone included in a voice signal of a user in an analog method according to an exemplary embodiment.

Referring to FIG. 6, a tone detector 600 includes a plurality of peak detectors 610 and a ratio detector 620. Here, the tone detector 600 includes N1 peak detectors 610, which are of the same number as first frequency bands to be received from a filter array.

The peak detectors 610 detect magnitudes of the first frequency bands that are received from the filter array. The peak detectors 610 transmits, to the ratio detector 620, the detected magnitudes of the first frequency bands.

In an example, the ratio detector 620 may calculate a similarity between a ratio of the magnitudes of the first frequency bands and a ratio of magnitudes of third frequency bands of a preregistered voice signal. The ratio detector 620 may include a digital or an analog circuit. For example, when the calculated similarity is greater than a predetermined threshold value, the ratio detector 620 may determine that a tone included in an analog voice signal of a user corresponds to a tone included in the preregistered voice signal. Conversely, when the calculated similarity is less than the predetermined threshold value, the ratio detector 620 may determine that the tone included in the analog voice signal of the user does not correspond to the tone included in the preregistered voice signal.

In another example, the tone detector 600 may include an analog type neural network processor in lieu of the ratio detector 620. The analog type neural network processor may detect the tone included in the analog voice signal of the user by applying a neural network to the magnitudes of the first frequency bands that are received from the peak detectors 610.

FIG. 7 is a diagram illustrating an operation of extracting a text from a voice signal of a user in an analog method according to an exemplary embodiment.

Referring to FIG. 7, a word recognition processor 700 includes a plurality of peak detectors 710 and an RNN/HMM processor 720. Here, the word recognition processor 700 includes N2 peak detectors 710, which are of the same number as second frequency bands to be received from a filter array.

The peak detectors 710 detect magnitudes of the second frequency bands that are received from the filter array. The peak detectors 710 transmits the detected magnitudes of the second frequency bands to the RNN/HMM processor 720.

In an example, the RNN/HMM processor 720 may be a processor capable of performing any one of an RNN and an HMM. The RNN/HMM processor 720 may extract a text from an analog voice signal of a user by applying any one of the RNN and the HMM to the magnitudes of the second frequency bands that are received from the peak detectors 710.

The RNN/HMM processor 720 determines whether the text extracted from the analog voice signal of the user corresponds to a text extracted from a preregistered voice signal, and determines whether to unlock a user terminal based on a result of the determining.

In another example, an analog type user terminal may include a microphone, a filter array, a spike generator, and a spiking neural network processor. The user terminal may convert a plurality of frequency bands from the filter array to a spike signal through the spike generator. In addition, the user terminal may detect a tone included in a analog voice signal of a user, and extract a text from the analog voice signal, through the spiking neural network processor.

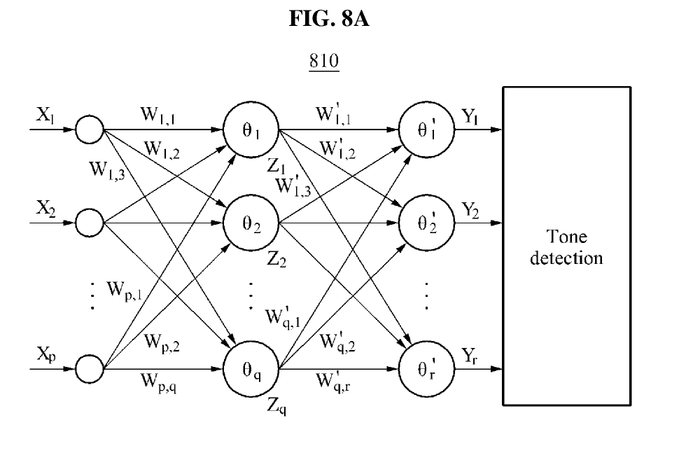

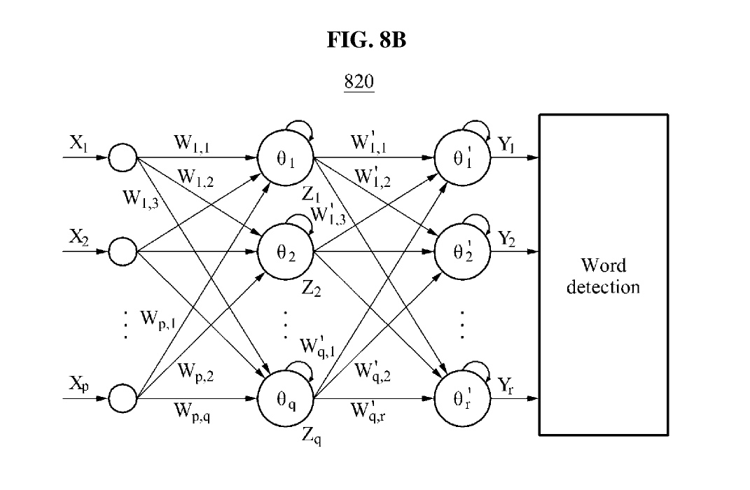

FIGS. 8A and 8B are diagrams illustrating operations using a neural network 810 and an RNN 820, respectively, according to exemplary embodiments.

FIG. 8A illustrates the neural network 810, and FIG. 8B illustrates the RNN 820. A user terminal may detect a tone included in a voice signal of a user (i.e., perform a tone detection) using the neural network 810, and extract a text from the voice signal of the user (i.e., perform a word detection) using the RNN 820. However, a neural network and an RNN that are used by the user terminal may not be limited to the examples of the neural network 810 and the RNN 820 illustrated in FIGS. 8A and 8B.

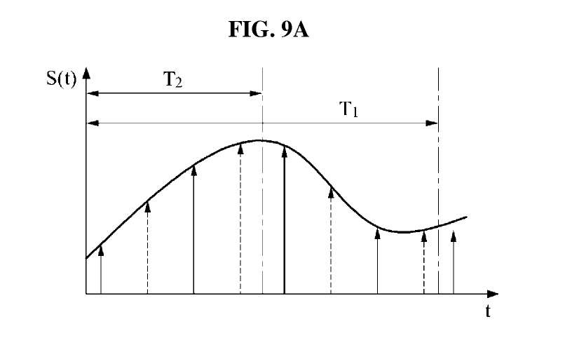

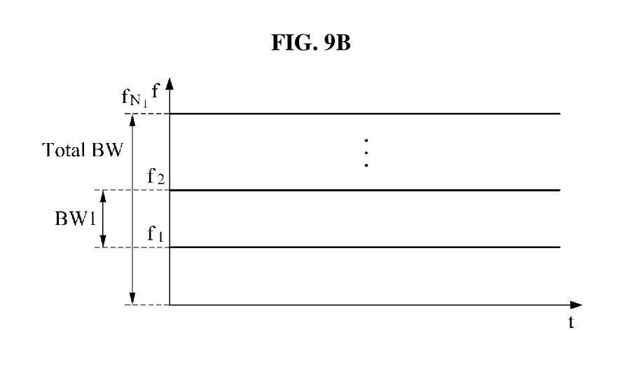

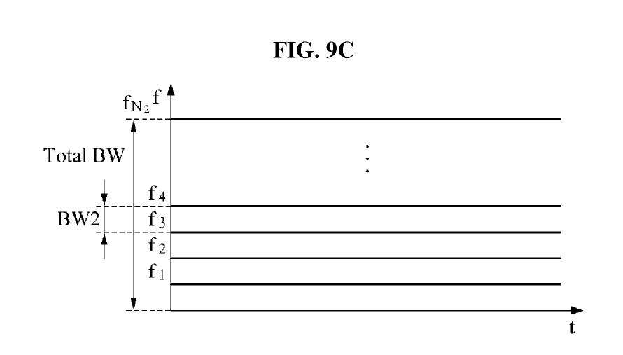

FIGS. 9A through 9C are diagrams illustrating an operation of sampling a voice signal of a user according to an exemplary embodiment.

Referring to FIG. 9A, a user terminal may perform sampling of a voice signal S(t) input from a user during a period of time T₁. An unlocking determiner of the user terminal may extract a text from the voice signal S(t) by performing full-sampling of the voice signal S(t). For example, signals corresponding to arrows indicated in solid lines and broken lines in FIG. 9A may be sampled by the unlocking determiner.

In addition, a wakeup determiner of the user terminal may detect a tone included in the voice signal S(t) by performing sub-sampling of the voice signal S(t). The wakeup determiner may perform the sampling of the voice signal S(t) at a sampling rate lower than a rate used in the unlocking determiner. For example, signals corresponding to arrows indicated in the solid lines in FIG. 9A may be sampled by the wakeup determiner. Thus, the wakeup determiner may process a less amount of computation than the unlocking determiner, and operate with low power.

FIG. 9B illustrates a plurality of first frequency bands generated by the wakeup determiner, and FIG. 9C illustrates a plurality of second frequency bands generated by the unlocking determiner. The first frequency bands are divided by a first frequency bandwidth BW1, and the second frequency bands are divided by a second frequency bandwidth BW2.

Referring to FIGS. 9A through 9C, each of the first frequency bands has the first frequency bandwidth BW1 broader than the second frequency bandwidth BW2 because the first frequency bands are generated by sub-sampling the voice signal S(t) during the period of time T₁. Here, the first frequency bands and the second frequency bands may have an equal total bandwidth BW because both the first frequency bands and the second frequency bands are generated by sampling the voice signal S(t) during the period of time T₁.

The wakeup determiner may detect the tone included in the voice signal S(t) by sampling the voice signal S(t) during a shorter period of time T₂ than the unlocking determiner at an equal sampling rate to the unlocking determiner. That is, when the unlocking determiner performs full-sampling of the voice signal S(t) during the period of time T₁, the wakeup determiner may perform full-sampling of the voice signal S(t) during the period of time T₂. When performing the sampling of the voice signal S(t) during the period of time T₂, the total BW of the first frequency bands may be narrower than the total BW of the second frequency bands.

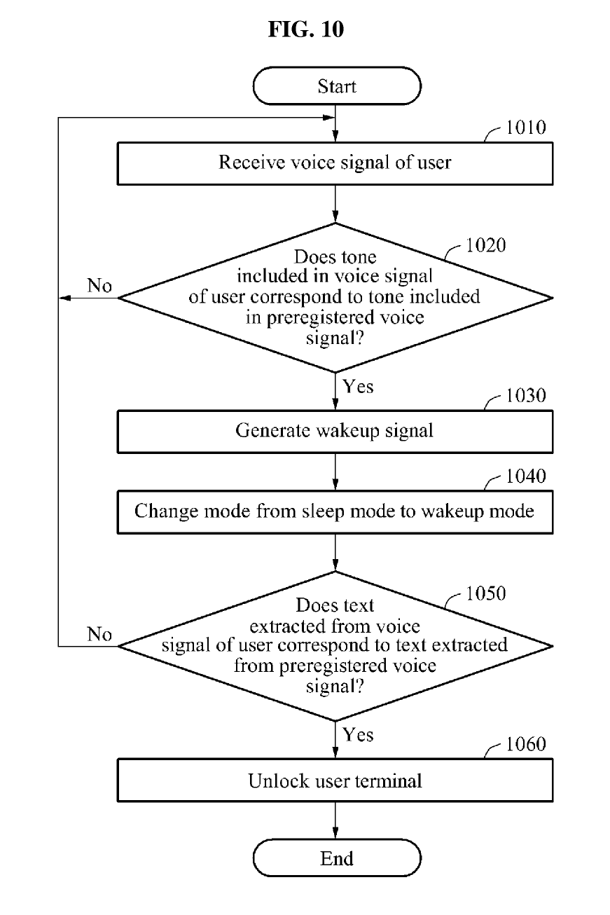

FIG. 10 is a flowchart illustrating a method of unlocking a user terminal to be performed by the user terminal according to an exemplary embodiment.

Referring to FIG. 10, operation 1010 is performed by a microphone of the user terminal, operations 1020 and 1030 are performed by a wakeup determiner of the user terminal, operations 1040 and 1050 are performed by an unlocking determiner of the user terminal, and operation 1060 is performed by the user terminal.

In operation 1010, the user terminal receives a voice signal of a user.

In operation 1020, the user terminal determines whether a tone included in the voice signal of the user corresponds to a tone included in a preregistered voice signal. When the tone included in the voice signal of the user is determined to not correspond to the tone included in the preregistered voice signal, the user terminal returns to operation 1010 to receive a voice signal of a user again. When the tone included in the voice signal of the user is determined to correspond to the tone included in the preregistered voice signal, the user terminal continues in operation 1030.

In operation 1030, the user terminal generates a wakeup signal that wakes up a processor performing voice recognition. The processor performing the voice recognition refers to the unlocking determiner.

In operation 1040, the user terminal changes a mode of the processor from a sleep mode to a wakeup mode.

In operation 1050, the user terminal determines whether a text extracted from the voice signal of the user corresponds to a text extracted from the preregistered voice signal. When the text extracted from the voice signal of the user is determined to not correspond to the text extracted from the preregistered voice signal, the user terminal may change the mode of the processor from the wakeup mode to the sleep mode, and returns to operation 1010 to receive a voice signal of a user again. When the text extracted from the voice signal of the user is determined to correspond to the text extracted from the preregistered voice signal, the user terminal continues in operation 1060.

In operation 1060, the user terminal unlocks the user terminal.

The operations described with reference to FIGS. 1 through 9 may be applicable to each operation described with reference to FIG. 10 and thus, repeated descriptions will be omitted here for brevity.

According to exemplary embodiments, determining whether to unlock a user terminal through two steps may enable minimization of an amount of power consumed in the user terminal.

According to exemplary embodiments, a user terminal may operate with low power due to an unlocking determiner operating in a sleep mode until a wakeup signal is generated.

According to exemplary embodiments, an amount of power consumed in a sensor and a processor included in a user terminal may be effectively managed by changing a mode of an unlocking determiner to a sleep mode when the user terminal is not unlocked within a predetermined period of time after the mode of the unlocking determiner is changed to a wakeup mode.

According to exemplary embodiments, providing a method of unlocking a user terminal based on a voice in lieu of a touch or an action may enable a user to command the unlocking only through the voice without directly touching the user terminal or moving a hand.

The above-described exemplary embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the exemplary embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, the present inventive concept is not limited thereto. Instead, it will be appreciated by those skilled in the art that changes may be made to these exemplary embodiments without departing from the principles and spirit of the disclosure, the scope of which is defined by the claims and their equivalents.

What is claimed is:

1. A method of unlocking a user terminal, the method comprising:
determining whether to generate a wakeup signal that wakes up a processor, based on a tone comprised in a voice signal; and
determining, by the processor, whether to unlock the user terminal based on a text extracted from the voice signal, in response to the wakeup signal being generated.

2. The method of claim 1, further comprising:
changing, by the processor, from a sleep mode to a wakeup mode in response to the wakeup signal being generated.

3. The method of claim 1, wherein the determining whether to generate the wakeup signal comprises determining whether to generate the wakeup signal based on whether the tone comprised in the voice signal corresponds to a tone comprised in a preregistered voice signal.

4. The method of claim 1, wherein the determining whether to generate the wakeup signal comprises detecting the tone comprised in the voice signal based on a portion of the voice signal to be used by the processor.

5. The method of claim 1, wherein the determining whether to generate the wakeup signal comprises:
dividing the voice signal into frequency bands based on a first frequency bandwidth that is broader than a second frequency bandwidth to be used by the processor; and
detecting the tone comprised in the voice signal based on the frequency bands.

6. The method of claim 1, wherein the determining whether to generate the wakeup signal comprises detecting the tone comprised in the voice signal based on one of a ratio of magnitudes of frequency bands comprised in the voice signal, an application of a support vector machine to the frequency bands, and an application of a neural network to the frequency bands.

7. The method of claim 1, wherein the determining whether to unlock the user terminal comprises determining whether to unlock the user terminal based on whether the text extracted from the voice signal corresponds to a text extracted from a preregistered voice signal.

8. The method of claim 1, wherein the determining whether to unlock the user terminal comprises extracting the text from the voice signal based on one of a ratio of magnitudes of frequency bands comprised in the voice signal, an application of a recurrent neural network to the frequency bands, and an application of a hidden Markov model to the frequency bands.

9. The method of claim 1, further comprising changing, by the processor, from a wakeup mode to a sleep mode in response to the user terminal being not unlocked within a period of time from a point in time at which the processor receives the wakeup signal.

10. The method of claim 1, wherein the determining whether to generate the wakeup signal comprises transmitting the voice signal stored in a memory to the processor in response to the wakeup signal being generated.

11. A non-transitory computer-readable storage medium storing a program comprising instructions to cause a computer to perform the method of claim 1.

12. A user terminal comprising:
a wakeup determiner configured to determine whether to generate a wakeup signal that wakes up an unlocking determiner, based on a tone comprised in a voice signal; and
the unlocking determiner configured to determine whether to unlock the user terminal based on a text extracted from the voice signal, in response to the wakeup signal being generated.

13. The user terminal of claim 12, wherein the unlocking determiner is further configured to change from a sleep mode to a wakeup mode in response to the wakeup signal being generated.

14. The user terminal of claim 12, wherein the wakeup determiner is configured to determine whether to generate the wakeup signal based on whether the tone comprised in the voice signal corresponds to a tone comprised in a preregistered voice signal.

15. The user terminal of claim 12, wherein the wakeup determiner is configured to detect the tone comprised in the voice signal based on a portion of the voice signal to be used by the unlocking determiner.

16. The user terminal of claim 12, wherein the wakeup determiner is configured to:
divide the voice signal into frequency bands based on a first frequency bandwidth that is broader than a second frequency bandwidth to be used by the unlocking determiner; and
detect the tone comprised in the voice signal based on the frequency bands.

17. The user terminal of claim 12, wherein the wakeup determiner is configured to detect the tone comprised in the voice signal based on one of a ratio of magnitudes of frequency bands comprised in the voice signal, an application of a support vector machine to the frequency bands, and an application of a neural network to the frequency bands.

18. The user terminal of claim 12, wherein the unlocking determiner is configured to determine whether to unlock the user terminal based on whether the text extracted from the voice signal corresponds to a text extracted from a preregistered voice signal.

19. The user terminal of claim 12, wherein the unlocking determiner is configured to extract the text from the voice signal based on one of a ratio of magnitudes of frequency bands comprised in the voice signal, an application of a recurrent neural network to the frequency bands, and an application of a hidden Markov model to the frequency bands.

20. The user terminal of claim 12, wherein in response to the user terminal being not unlocked within a period of time from a point in time at which the unlocking determiner receives the wakeup signal, the unlocking determiner is configured to change the mode from a wakeup mode to a sleep mode.
